(19) United States
(12) Patent Application Publication
(10) Pub. No.: US 2024/0193073 A1
(43) Pub. Date: Jun. 13, 2024

(54) CONFIGURING A LAUNCH OF COMPONENTS OF A HARDWARE-IN-THE-LOOP SIMULATION ENVIRONMENT

(71) Applicant: Disney Enterprises, Inc., Burbank, CA (US)

(72) Inventors: Patrick MCNAULL, Winter Garden, FL (US); Matthew J. STRANDSKOV, Winter Garden, FL (US); Robert J. MARRA, Windermere, FL (US)

(73) Assignee: Disney Enterprises, Inc., Burbank, CA (US)

(21) Appl. No.: 18/064,920

(22) Filed: Dec. 12, 2022

(51) Int. Cl. G06F 11/36

(52) U.S. Cl. CPC G06F 11/3664

(57) ABSTRACT

In some implementations, a hardware-in-the-loop simulation (HIL) platform may receive component information regarding a plurality of software components of an HIL simulation environment. The component information may be received using a launcher application of the HIL simulation platform. The component information may include sequence information indicating a sequence for launching the plurality of software components during an HIL simulation, and interconnectivity information indicating an interdependency between two or more software components of the plurality of software components. The HIL simulation platform may receive a request to perform the HIL simulation. The HIL simulation platform may execute, based on the request, a computer model to perform the HIL simulation. Executing the computer model to perform the HIL simulation comprises launching, using the launcher application, the plurality of software components in an order that is based on the sequence.

### BACKGROUND

Hardware-in-the-loop (HIL) simulations are used in the development and test of complex real-time control systems. HIL simulations involve emulating multiple systems of a controlled environment to provide realistic inputs to a controller being developed or under test. Each external system that communicates with the controller is implemented by a mathematical representation (e.g., a software application) that produces signals and values that emulate the real-time controlled environment.

### SUMMARY

In some implementations, a method performed by a hardware-in-the-loop (HIL) simulation platform includes receiving, by a launcher application of the HIL simulation platform, component information regarding a plurality of software components of a HIL simulation environment, wherein the component information includes: sequence information indicating a sequence for launching the plurality of software components during a HIL simulation, and interconnectivity information indicating an interdependency between two or more software components of the plurality of software components; receiving a request to perform the HIL simulation; and executing, based on the request, a computer model to perform the HIL simulation, wherein executing the computer model to perform the HIL simulation comprises: launching, using the launcher application, the plurality of software components in an order that is based on the sequence.

In some implementations, a system includes a hardware-in-the-loop (HIL) simulation platform configured to: receive, by a launcher application of the HIL simulation platform, component information regarding a plurality of software components of an HIL simulation environment, wherein the component information includes: sequence information indicating a sequence for launching the plurality of software components during an HIL simulation, and interconnectivity information indicating an interdependency between two or more software components of the plurality of software components; launch, using the launcher application, the plurality of software components in an order that is based on the sequence, wherein the plurality of software components are launched during the HIL simulation; monitor, by the launcher application, the plurality of software components to determine a failure associated with launching the plurality of software components; and perform, by the launcher application, an action based on monitoring the plurality of software components.

In some implementations, a non-transitory computer-readable medium storing a set of instructions includes one or more instructions that, when executed by one or more processors of a device, cause the device to: receive, by a launcher application of the device, component information regarding a plurality of software components of a hardware-in-the-loop (HIL) simulation environment, wherein the component information includes: sequence information indicating a sequence for launching the plurality of software components during an HIL simulation; launch, using the launcher application, the plurality of software components in an order that is based on the sequence, wherein the plurality of software components are launched during the HIL simulation; and monitor, by the launcher application, the plurality of software components to determine a failure associated with launching the plurality of software components.

### BRIEF DESCRIPTION OF THE DRAWINGS

FIGS. 1A-1E are diagrams of an example implementation described herein.

FIG. 2 is a diagram of an example environment in which systems and/or methods described herein may be implemented.

FIG. 3 is a diagram of example components of one or more devices of FIG. 2.

FIG. 4 is a flowchart of an example process relating to configuration a launch of components of a simulation environment.

### DETAILED DESCRIPTION

The following detailed description of example implementations refers to the accompanying drawings. The same reference numbers in different drawings may identify the same or similar elements.

An HIL simulation involves emulating multiple systems, of a real-time controlled environment, to provide realistic inputs to a controller (e.g., an embedded system) that is being developed or is being tested (e.g., evaluated). A computer model, that models a behavior of the multiple systems and/or the controller, may be executed to cause the HIL simulation to be executed. Each system (e.g., external system) that communicates with the controller is implemented by a mathematical representation (e.g., a software application) that produces signals and values that emulate the real-time controlled environment.

One challenge, during the HIL simulation, is orchestrating a complex startup process. During the complex startup process, each software application (of multiple software applications representing the multiple systems) is to be launched in a particular order prior to the HIL simulation being executed. Additionally, each software application (e.g., emulator or simulator application) is to be in a particular operating state and is to establish connectivity with one or more other software applications prior to the HIL simulation being executed. Each software application is to be in a particular operating state and is to establish connectivity in order to properly emulate a system represented by the software application.

Typically, each software application (of the multiple software applications) is launched manually. Launching each software application manually is subject to human error. For example, one or more software applications may be launched in an improper order. Additionally, or alternatively, the one or more software applications may be launched in improper operating states. Additionally, or alternatively, improper interconnectivity may be established between the one or more software applications and one or more other software applications. Accordingly, the one or more software applications may be launched incorrectly. Accordingly, the startup process may be launched incorrectly.

As a result of the startup process being launched incorrectly, outputs of the HIL simulation may be inaccurate or inconsistent. The inaccuracy and/or inconsistency of the outputs may cause the controller to be improperly developed and/or to be improperly tested. As a result of the controller being improperly developed and/or to be improperly tested, systems that are controlled by the controller and/or that interact with the controller may operate improperly and/or inconsistently.

Additionally to being subject human error, launching each software application manually requires a significant amount of training to be provided to a modeler of the computer model (e.g., to enable the modeler to properly set up an HIL simulation environment). Such a significant amount of training may be time consuming. In some instances, the startup process may be launched using a scripting language. Using the scripting language in this manner does not provide a reusable framework that can be applied to a wide variety of applications. For example, using the scripting language in this manner limits the HIL simulation to a specific application.

Furthermore, currently, the startup process does not provide a functionality for monitoring the software applications to determine whether the software applications experienced failures during the startup process. For example, currently, a software application may fail to launch and/or may unexpectedly fail after launch. In this regard, the HIL simulation may be executed without any knowledge that the software application experienced a failure. Accordingly, outputs of the HIL simulation may be inaccurate and/or inconsistent.

Implementations described herein are directed to a launcher application that is used to orchestrate a startup and interconnectivity process for all software components that interact with a controller during an HIL simulation. The launcher application may include a computer program that is configured to locate and launch the software components for the HIL simulation. The software components may include software applications and/or software programs, among other examples. The software components may emulate or simulate systems of different industries, such as automotive, manufacturing, healthcare, mining, construction, farming, transportation, amusement parks, among other examples.

The launcher application may be configured with information identifying a launch order for the software components. For example, the launcher application may be configured with sequence information identifying a sequence for launching each software component. In this regard, the launch order may identify the sequence for launching each software component.

Additionally, the launcher application may be configured with connectivity information identifying interconnectivity between the software components. As an example, during configuration of the launcher application (and therefore configuration of the HIL simulation), each software component required by the HIL may be added to the launch order.

Additionally, startup arguments may be provided via the launcher application. The startup arguments may be used to control the interconnectivity between the software components provided. In some instances, the startup arguments may indicate that launching a first software component may affect launching a second software component, as the two software components are interdependent. For example, the startup arguments may indicate that launching the second software component is dependent on the successful launching of the first software component (e.g., successfully launching the first software component).

In some situations, the startup arguments may be included configuration information for the software components. The configuration information, for a particular software component, may include one or more of file path information identifying a file path for the particular software component, one or more parameters to be used when launching the particular software component, and log file information identifying a location of a log file for the particular software component.

A configuration file may be generated based on configuring the launcher application. The configuration file may be saved and reloaded. For example, the configuration file may be reloaded and used to launch the software components for the HIL simulation. Additionally, or alternatively, the configurations file may be reloaded and used to launch the software components for another HIL simulation that involves the software components being launched in accordance with the launch order.

Additionally, or alternatively, the configuration file may be reloaded and modified for one or more additional HIL simulations. For example, the launch order may be modified, one or more of the software components may be removed, one or more additional software components may be included in the launch order, among other examples. In this regard, the configuration file may be modified to create a different configuration file that may be saved and reloaded.

Therefore, multiple configuration files may be generated for different simulation environments. The launcher application may be readily adapted to any simulation environment and may be customizable to incorporate software components unique to each HIL configuration. The one or more configurations files may enable the modeler or other individual to quickly switch between startup environments.

Once the launcher application has been configured, an HIL simulation environment (associated with the HIL simulation) may be launched using a single user interface of the launcher application. For example, the HIL simulation environment may be launched using a single button click. By using the single button click, each component may be launched in accordance with the launch order and interconnectivity may be established between two or more software components. Utilizing the configuration files in this manner may enable a modeler or another individual to quickly switch between startup environments. Utilizing the launcher application as described herein in this manner may enable a consistent startup of the software components, thereby enabling accurate and consistent results of the HIL simulation.

The launcher application is configured to provide a notification (e.g., to a modeler or another individual) if any of the software components fails to launch or exits unexpectedly (e.g., unexpectedly experiences a failure after launch). By providing the notification in this manner, the modeler or another individual may become aware of failures or other issues occurring during the launch of the HIL simulation environment. Accordingly, the modeler or another individual may take appropriate actions to prevent incorrect behavior of the systems emulated by the software components. Preventing the incorrect behavior of the systems may prevent incorrect and/or inconsistent outputs of the HIL simulation.

The launcher application may be configured to automate the startup process for the software components. Automating the startup process, using the launcher application, eliminates training that is typically provided (e.g., to a modeler or another individual) with respect to properly launching the software components. While the launcher application has been described with respect to an HIL simulation and an HIL simulation environment, the launcher application may be utilized with other HIL simulations and other HIL simulation environments.

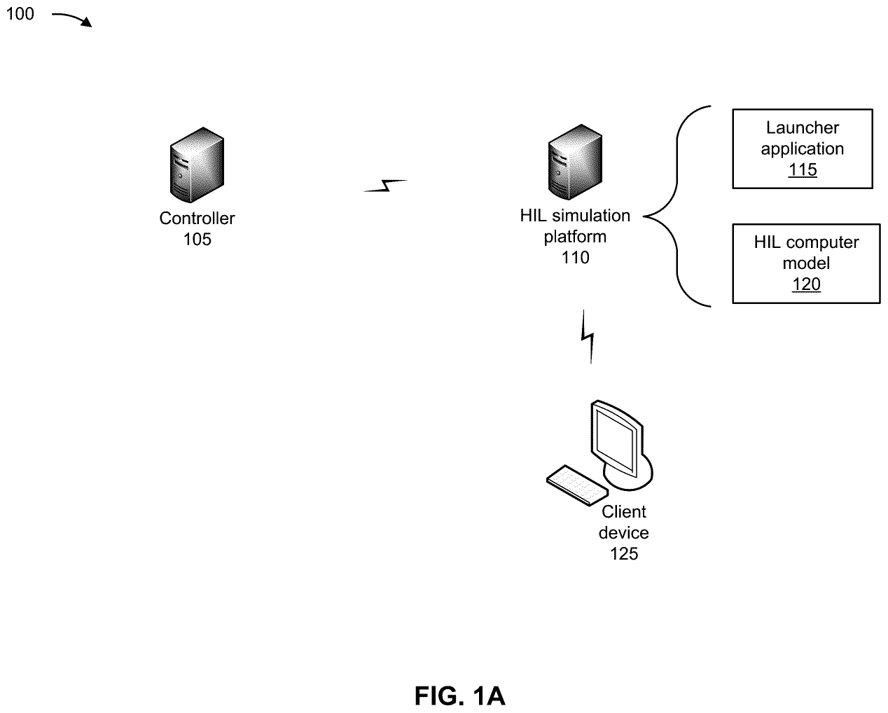

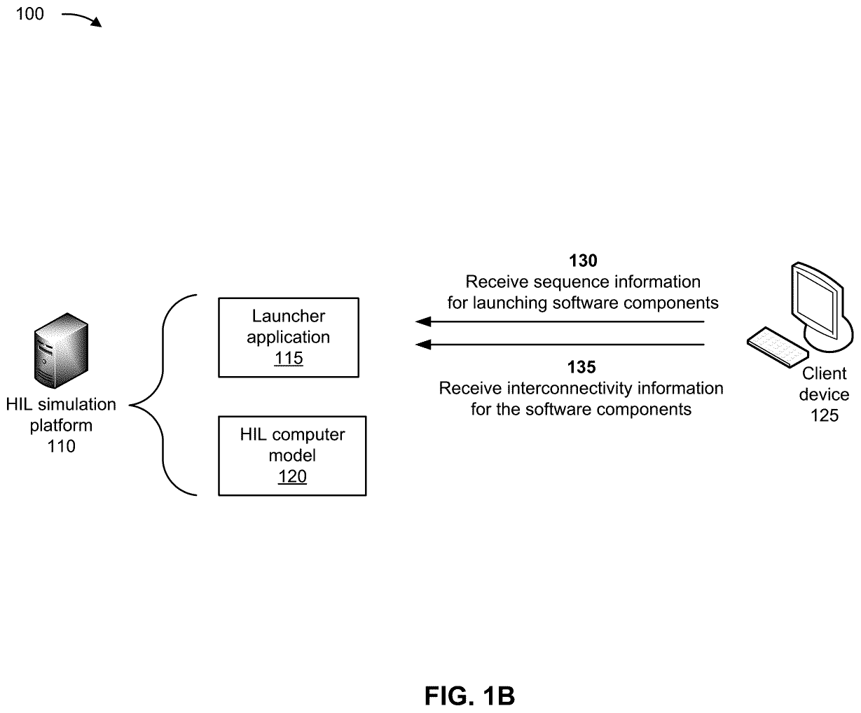

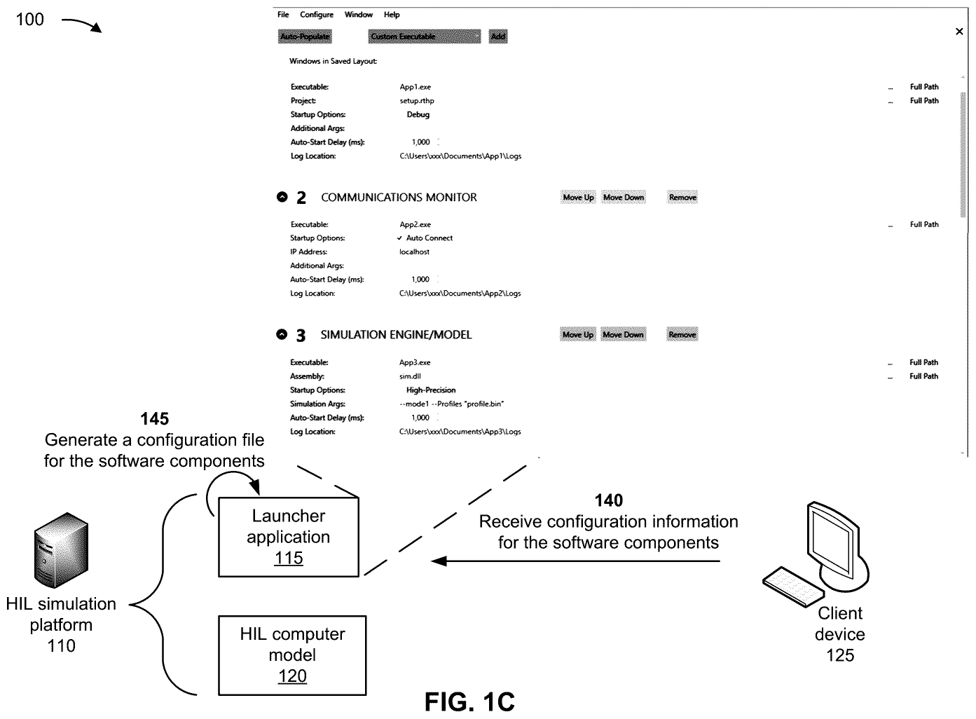

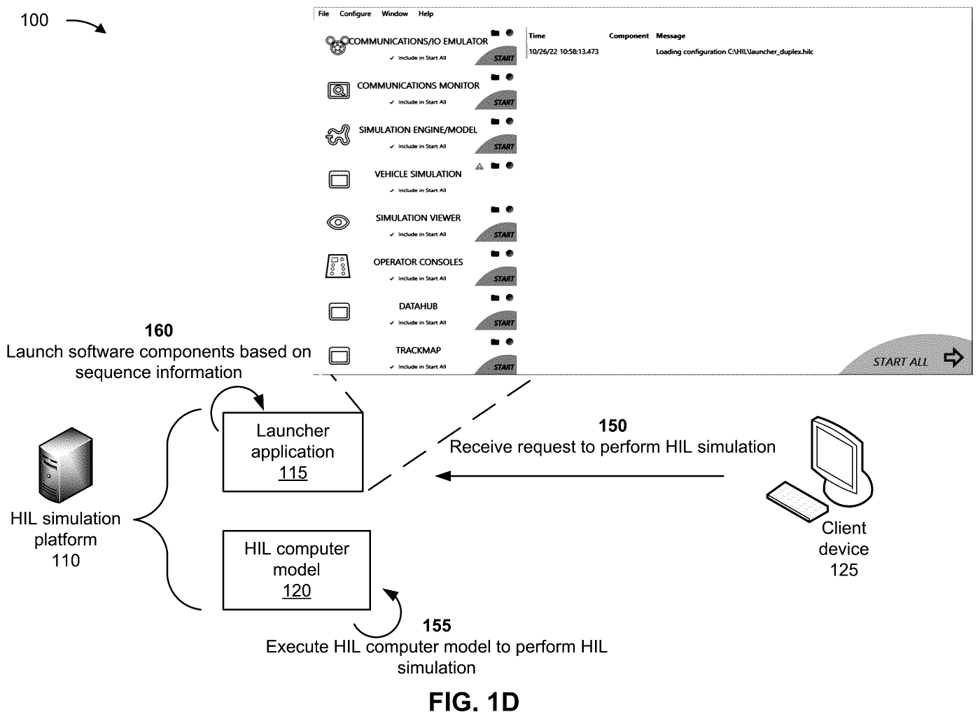

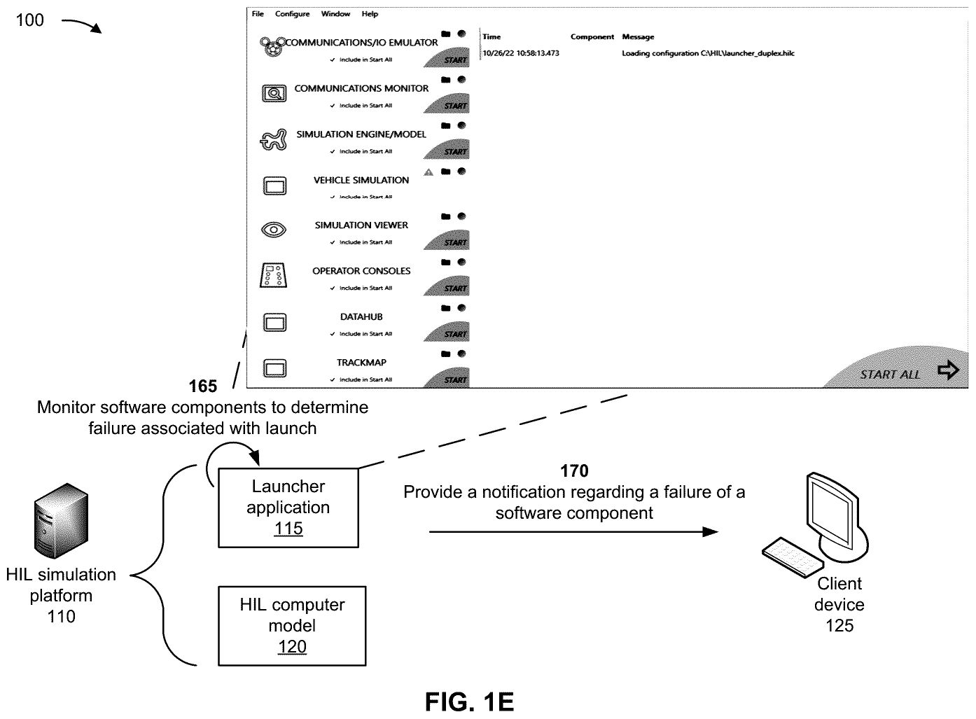

FIGS. 1A-1E are diagrams of an example implementation 100 associated with configuring a launch of components of a simulation environment. As shown in FIGS. 1A-1E, example implementation 100 includes a controller 105, an HIL simulation platform 110, and a client device 125. Controller 105 may include one or more devices configured to control operations of multiples systems or devices of different industries (e.g., automotive, manufacturing, healthcare, mining, construction, farming, transportation, and/or amusement parks, among other examples). In some situations, controller 105 may provide multiple inputs (e.g., thousands of inputs) to the systems to control the systems.

In the context of amusement parks as an examples, the systems or devices may include components of a ride system and/or of a show system, such as passenger vehicles, location sensors, speed sensors, brake systems, motors, animatronic equipment, and/or lighting equipment, among other examples. In some implementations, controller 105 may include a programmable logic controller. In some situations, the programmable logic controller may be referred to as a wayside ride control system (WRCS).

HIL simulation platform 110 may include one or more devices configured to host an HIL simulation environment. As shown in FIG. 1A, HIL simulation platform 110 may include a launcher application 115 and an HIL computer model 120. Launcher application 115 may include a computer program that is configured to locate and launch software components for an HIL simulation. Launcher application 115 may be configured with sequence information identifying a sequence for launching each software component and may launch each software component according to the sequence.

Additionally, or alternatively, launcher application 115 may be configured with configuration information for the software components. The configuration information, for a particular software component, may include file path information identifying a file path for the particular software component, information regarding an operating state of the particular software component when launching the particular software component, one or more parameters used when launching the particular software component, and/or log file information identifying a location of a log file for the particular software component.

Additionally, or alternatively, launcher application 115 may be configured to monitor the software components during a launch of each software component. Based on monitoring the launch of each software component, launcher application 115 may provide notifications to indicate that the software component failed to launch or experienced a failure after the launch. As an example, launcher application 115 may use the file path information to identify the file path to launch the software component, may use the one or more parameters as arguments to be used during the launch of the particular software component, may ensure that the software component is in the proper operating state, and may use the log file to record any failure experienced by the software component during the launch. HIL computer model 120 may include a computer model that is executed to a launch the HIL simulation. For example, HIL computer model 120 may be configured to execute HIL computer model 120 to launch the HIL simulation.

Client device 125 may include one or more devices capable of configuring launcher application 115. Additionally, or alternatively, client device 125 may be capable of receiving (e.g., from HIL simulation platform 110) outputs of HIL simulations (e.g., thousands of outputs) and provide the outputs for display (e.g., to a modeler of HIL computer model 120, to an individual associated with client device 125, among other examples). In some implementations, client device 125 may include launcher application 115. Additionally, or alternatively, client device 125 may be configured to execute HIL computer model 120 in a manner similar to a manner in which HIL simulation platform 110 executes HIL computer model 120.

As shown in FIG. 1B, and by reference number 130, HIL simulation platform 110 may receive sequence information for launching software components. For example, a modeler of HIL computer model 120 may desire to configure launcher application 115 to launch the software components in a particular sequence for an HIL simulation. In this regard, the modeler may use client device 125 to provide component information regarding the software components. The component information may provide, to HIL simulation platform 110, the sequence information that identifies the particular sequence in which the software components are to be launched. The sequence information may include information identifying the software components and information identifying the particular sequence. For example, the particular sequence may indicate that a first software component is to be launched, followed by a second software component, followed by a third software component, and so on.

The software components may include software applications that emulate systems of different industries, such as automotive, manufacturing, healthcare, mining, construction, farming, transportation, amusement parks, among other examples. The software components may include emulators, simulators, among other examples.

As shown in FIG. 1B, and by reference number 135, HIL simulation platform 110 may receive interconnectivity information for the software components. For example, HIL simulation platform 110 may receive the interconnectivity information from client device 125 as part of configuring launcher application 115. The interconnectivity information may be included in the component information. The interconnectivity information may indicate an interdependency between two or more of the software components. For example, the interconnectivity information may indicate that launching the third component may depend on an outcome of launching the second component.

As shown in FIG. 1C, and by reference number 140, HIL simulation platform 110 may receive configuration information for the software components. For example, HIL simulation platform 110 may receive the configuration information from client device 125 as part of configuring launcher application 115. The configuration information may be included in the component information.

In some examples, the configuration information for the particular software component may include file path information identifying a file path for the particular software component, one or more parameters used when launching the particular software component, and/or log file information identifying a location of a log file for the particular software component. In some examples, the file path may identify a location of an executable file for the particular software component.

The configuration information has been received for four software components, namely a first software component (e.g., a communications/IO emulator), a second software component (e.g., a communications monitor), a third software component (e.g., a simulation engine/model), and a fourth software component (e.g., a vehicle simulation). As shown in FIG. 1C, launcher application 115 may provide a graphical user interface that displays the configuration information of the four software components.

As an example, the first software component may perform data signaling between other software components. The second software component may provide a visualization of the data signaling. The third software component may execute a simulation engine to simulate a system. The fourth software component may be a tool that interfaces with simulated objects of the system to cause the simulated objects to move in the system.

As shown in FIG. 1C, the configuration information for the first software component may include a file path for an executable file of the first software component and include a location for a log file for the first software component. As shown in FIG. 1C, the configuration information may be updated, via the graphical user interface, to include startup arguments (or parameters) to be used when launching the first software component (e.g., parameters that are to be provided upon startup of the first software component). In some instances, the configuration information of one software component may be different than the configuration information of another software component. For example, the configuration information of the third software component may include arguments (or parameters) for the simulation. Such arguments are not included in the configuration information of the first software component.

As shown in FIG. 1C, and by reference number 145, HIL simulation platform 110 may generate a configuration file for the software components. In some implementations, launcher application 115 may be configured (to launch the software components) using the sequence information, the interconnectivity information, and the configuration information. As a result of configuring launcher application 115, the configuration file may be generated.

The configuration file may include the sequence information, the interconnectivity information, and the configuration information. The configuration file may be stored and subsequently retrieved for use in launching the software components, for use in causing the software components to be in appropriate operating states, for use in monitoring the launch of the software components, among other examples. In some implementations, the configuration file may be stored on one or more memories associated with HIL simulation platform 110. Additionally, or alternatively, the configuration file may be stored on one or more memories associated with client device 125.

As shown in FIG. 1D, and by reference number 150, HIL simulation platform 110 may receive a request to perform an HIL simulation. For example, HIL simulation platform 110 may receive the request from client device 125. In some implementations, launcher application 115 may provide a graphical user interface to client device 125 and client device 125 may provide the request via the graphical user interface. In some instances, the request may identify the software components that are to be launched as part of executing HIL computer model 120 to perform the HIL simulation. In some instances, based on the request, launcher application 115 may retrieve the configuration file from the one or more memories (e.g., associated with HIL simulation platform 110).

Launcher application 115 may cause the graphical user interface to display information regarding the software components. For example, as shown in FIG. 1D, the graphical user interface may identify information identifying the software components and may indicate whether one or more software components are to be included during the launch of the one or more software component. In some implementations, the graphical user interface may provide a single input element (e.g., a single button) that may enable all the software components to be launched as part of executing HIL computer model 120.

As shown in FIG. 1D, and by reference number 155, HIL simulation platform 110 may execute HIL computer model 120 to perform the HIL simulation. In some instances, HIL computer model 120 may receive the request as a result client device 125 selecting the single input element.

As shown in FIG. 1D, and by reference number 160, HIL simulation platform 110 may launch the software components based on the sequence information. For example, as part of executing HIL computer model 120 to perform the HIL simulation, HIL simulation platform 110 may launch the software components based on the sequence information identified in the configuration file. In some implementation, HIL simulation platform 110 (e.g., via launcher application 115) may control an interdependency between two or more software components based on the interconnectivity information include in the configuration file. For example, launcher application 115 may ensure that information regarding an outcome of launching the second component is used during a launch of the third component.

As shown in FIG. 1E, and by reference number 165, HIL simulation platform 110 may monitor the software components to determine failures associated with the software components. HIL simulation platform 110 (e.g., using launcher application 115) may monitor the software components to determine whether any software component experienced a failure during a launch or unexpectedly experienced a failure after the launch.

As shown in FIG. 1E, a software component may be launched and may be stopped individually. HIL simulation platform 110 (e.g., using launcher application 115) may monitor the software component to determine whether the software component experienced a failure.

As shown in FIG. 1E, and by reference number 170, HIL simulation platform 110 may provide a notification regarding a failure of a software component. For example, based on determining that the software component failed to launch or unexpectedly experienced a failure after the launch, HIL simulation platform 110 (e.g., using launcher application 115) may provide the notification to client device 125. In some instances, HIL simulation platform 110 may provide the notification via the graphical user interface.

Implementations described herein enables a consistent launch sequence of the HIL simulation environment every time the HIL simulation environment is launched. Compared to a manual startup, implementations described herein require less training to learn the system and reduces the likelihood of missing a step in the sequence and having to start over. Compared to a startup using a scripting language, implementations described herein provide a reusable framework that can be applied to a wide variety of applications. Furthermore, implementations described herein monitor an overall simulation environment to provide notifications any potential issues.

Automating the startup process removes any manual fine tuning and training that is typically used to set up an HIL simulation environment. Results are more consistent and reliable. The launch order (or sequence) reliably sets initial operating states of the software components and/or of the computer model each time the computer model is executed. In this regard, implementations described herein enable consistent set up and startup of complex simulations.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

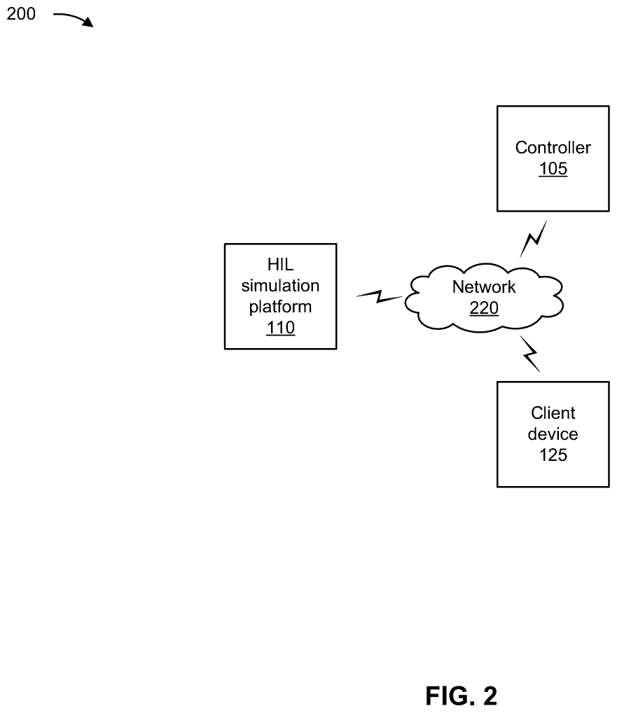

FIG. 2 is a diagram of an example environment 200 in which systems and/or methods described herein may be implemented. Some elements of environment 200 have been described above in connection with FIG. 1. In some implementations, HIL simulation platform 110 may include one or more elements of and/or may execute within a cloud computing system. As further shown in FIG. 2, environment 200 may include controller, client device 125, and/or a network 220. Devices and/or elements of environment 200 may interconnect via wired connections and/or wireless connections.

In some situations, HIL simulation platform 110 may be implemented on a server, such as an application server, a client server, a web server, a database server, a host server, a proxy server, a virtual server (e.g., executing on computing hardware), or a server in a cloud computing system. In some implementations, HIL simulation platform 110 implemented on using computing hardware used in a cloud computing environment.

Client device 125 includes one or more devices capable of receiving, generating, storing, processing, and/or providing information associated with configuring a launch of software components, as described elsewhere herein. Client device 125 may include a communication device and a computing device. For example, client device 125 may include a wireless communication device, a mobile phone, a user equipment, a laptop computer, a tablet computer, a desktop computer, or a similar type of device.

Network 220 includes one or more wired and/or wireless networks. For example, network 220 may include a cellular network, a public land mobile network (PLMN), a local area network (LAN), a wide area network (WAN), a private network, the Internet, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

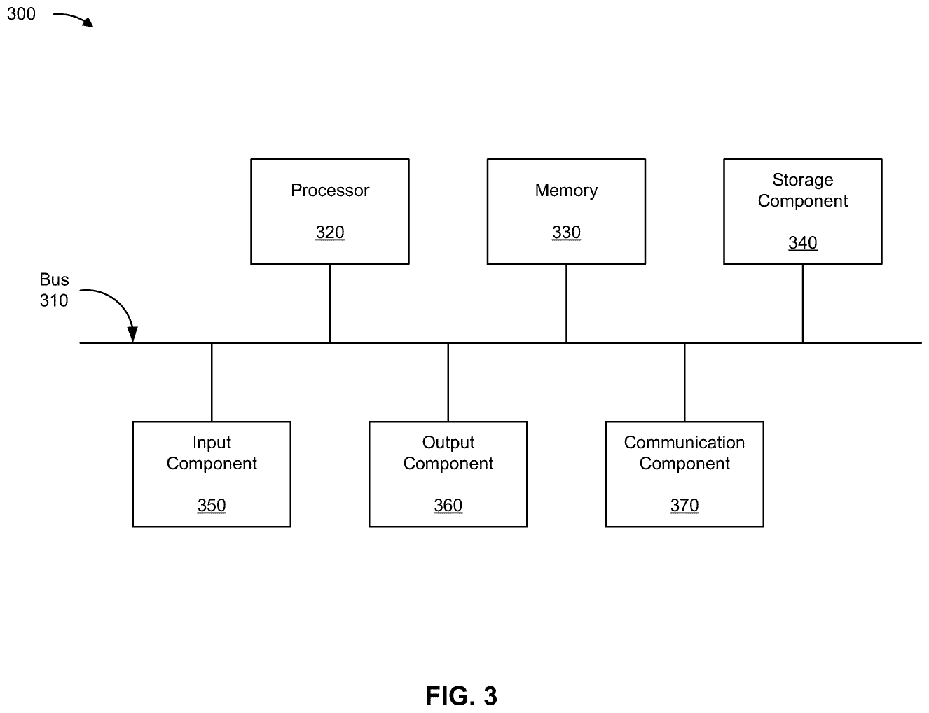

FIG. 3 is a diagram of example components of a device 300, which may correspond to HIL simulation platform 110, controller 105, and/or client device 125. In some implementations, HIL simulation platform 110, controller 105, and/or client device 125 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

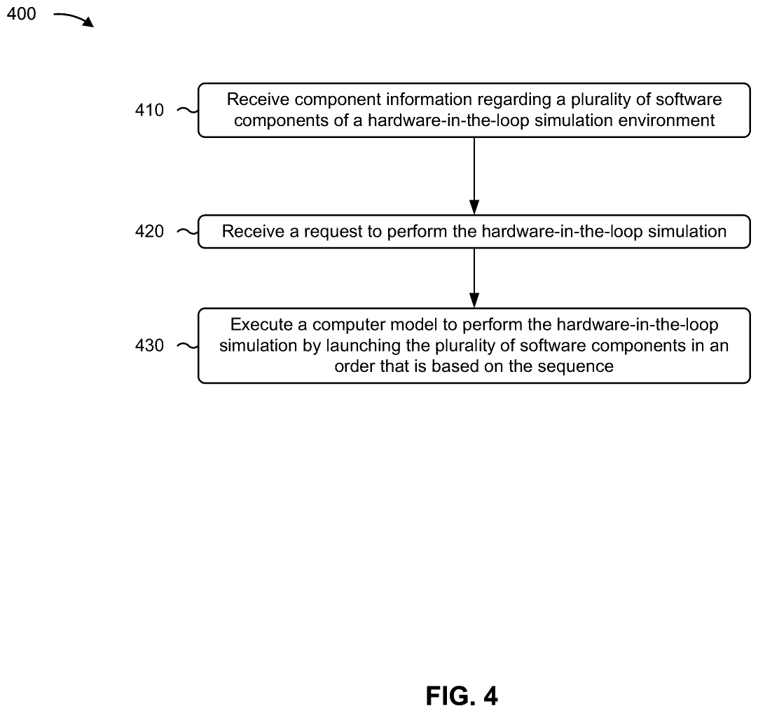

FIG. 4 is a flowchart of an example process 400 relating to configuration a launch of components of a simulation environment. In some implementations, one or more process blocks of FIG. 4 may be performed by an HIL simulation platform (e.g., launcher application 115 of HIL simulation platform 110). In some implementations, one or more process blocks of FIG. 4 may be performed by another device or a group of devices separate from or including the launcher application of the HIL simulation platform, such as a controller (e.g., controller 105) and/or by a client device (e.g., client device 125). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving component information regarding a plurality of software components of an HIL simulation environment, wherein the component information includes: sequence information indicating a sequence for launching the plurality of software components during an HIL simulation, and interconnectivity information indicating an interdependency between two or more software components of the plurality of software components (block 410). For example, the launcher application of the HIL simulation platform may receive component information regarding a plurality of software components of an HIL simulation environment, wherein the component information includes: sequence information indicating a sequence for launching the plurality of software components during an HIL simulation, and interconnectivity information indicating an interdependency between two or more software components of the plurality of software components, as described above. In some implementations, the component information includes: sequence information indicating a sequence for launching the plurality of software components during an HIL simulation, and interconnectivity information indicating an interdependency between two or more software components of the plurality of software components.

As further shown in FIG. 4, process 400 may include receiving a request to perform the HIL simulation (block 420). For example, the launcher application of the HIL simulation platform may receive a request to perform the HIL simulation, as described above.

As further shown in FIG. 4, process 400 may include executing, based on the request, a computer model to perform the HIL simulation, wherein executing the computer model to perform the HIL simulation comprises: launching, using the launcher application, the plurality of software components in an order that is based on the sequence (block 430). For example, the launcher application of the HIL simulation platform may execute, based on the request, a computer model to perform the HIL simulation, wherein executing the computer model to perform the HIL simulation comprises: launching, using the launcher application, the plurality of software components in an order that is based on the sequence, as described above. In some implementations, executing the computer model to perform the HIL simulation comprises: launching, using the launcher application, the plurality of software components in an order that is based on the sequence.

Process 400 may include additional implementations, such as any single implementation or any combination of implementations described below and/or in connection with one or more other processes described elsewhere herein.

In a first implementation, process 400 includes monitoring, by the launcher application, the plurality of software components to determine whether the plurality of software components failed to launch, and providing a notification based on determining that a software component, of the plurality of software components, failed to launch.

In a second implementation, receiving the request comprises receiving the request based on a single input from a user interface element of the launcher application, wherein the plurality of software components are launched, in the order, based on the single input.

In a third implementation, receiving the component information comprises receiving configuration information for a particular software component of the plurality of software components, wherein the configuration information includes one or more of file path information identifying a file path for the particular software component, one or more parameters used when launching the particular software component, and log file information identifying a location of a log file for the particular software component.

In a fourth implementation, the HIL simulation is a first HIL simulation, wherein the request is a first request, and wherein the method further comprises storing the component information as a configuration file for the launcher application, receiving a second request to perform a second HIL simulation, obtaining, using the launcher application and based on the second request, the configuration file, and launching, using the launcher application and based on the second request, the plurality of software components in an order that is based on the sequence identified by the configuration file.

In a fifth implementation, process 400 includes controlling, by the launcher application, the interdependency of the two or more software components based on the interconnectivity information.

In a sixth implementation, process 400 includes receiving, by the launcher application, information regarding one or more additional software components, updating, by the launcher application, the component information to generate updated component information, wherein the updated component information identifies the one or more additional software components, and wherein the updated component information includes updated sequence information indicating an updated sequence for launching the plurality of software components and the one or more additional software components, and launching, during another HIL simulation, the plurality of software components and the one or more additional software components in an order that is based on the updated sequence.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a hardware-in-the-loop (HIL) simulation platform, the method comprising:
receiving, by a launcher application of the HIL simulation platform, component information regarding a plurality of software components of an HIL simulation environment,
wherein the component information includes:
sequence information indicating a sequence for launching the plurality of software components during an HIL simulation, and
interconnectivity information indicating an interdependency between two or more software components of the plurality of software components;
receiving a request to perform the HIL simulation; and
executing, based on the request, a computer model to perform the HIL simulation,
wherein executing the computer model to perform the HIL simulation comprises:
launching, using the launcher application, the plurality of software components in an order that is based on the sequence.

2. The method of claim 1, further comprising:
monitoring, by the launcher application, the plurality of software components to determine whether the plurality of software components failed to launch; and
providing a notification based on determining that a software component, of the plurality of software components, failed to launch.

3. The method of claim 1, wherein receiving the request comprises:
receiving the request based on a single input from a user interface element of the launcher application,
wherein the plurality of software components are launched, in the order, based on the single input.

4. The method of claim 1, wherein receiving the component information comprises:
receiving configuration information for a particular software component of the plurality of software components,
wherein the configuration information includes one or more of file path information identifying a file path for the particular software component, one or more parameters used when launching the particular software component, and log file information identifying a location of a log file for the particular software component.

5. The method of claim 1, wherein the HIL simulation is a first HIL simulation,
wherein the request is a first request, and
wherein the method further comprises:
storing the component information as a configuration file for the launcher application;
receiving a second request to perform a second HIL simulation;
obtaining, using the launcher application and based on the second request, the configuration file; and
launching, using the launcher application and based on the second request, the plurality of software components in an order that is based on the sequence identified by the configuration file.

6. The method of claim 1, further comprising:
controlling, by the launcher application, the interdependency of the two or more software components based on the interconnectivity information.

7. The method of claim 1, further comprising:
receiving, by the launcher application, information regarding one or more additional software components;
updating, by the launcher application, the component information to generate updated component information,
wherein the updated component information identifies the one or more additional software components, and
wherein the updated component information includes updated sequence information indicating an updated sequence for launching the plurality of software components and the one or more additional software components; and
launching, during another HIL simulation, the plurality of software components and the one or more additional software components in an order that is based on the updated sequence.

8. A system, comprising:
A hardware-in-the-loop (HIL) simulation platform configured to:
receive, by a launcher application of the HIL simulation platform, component information regarding a plurality of software components of an HIL simulation environment,
wherein the component information includes:
sequence information indicating a sequence for launching the plurality of software components during an HIL simulation, and
interconnectivity information indicating an interdependency between two or more software components of the plurality of software components;
launch, using the launcher application, the plurality of software components in an order that is based on the sequence,
wherein the plurality of software components are launched during the HIL simulation;
monitor, by the launcher application, the plurality of software components to determine a failure associated with launching the plurality of software components; and
perform, by the launcher application, an action based on monitoring the plurality of software components.

9. The system of claim 8, wherein, to perform the action, the HIL simulation platform is further configured to:
provide, using the launcher application, a notification based on determining that a software component, of the plurality of software components, failed to launch.

10. The system of claim 8, wherein, to perform the action, the HIL simulation platform is further configured to:
provide, using the launcher application, a notification based on determining that a software component, of the plurality of software components, failed after being launched.

11. The system of claim 8, wherein, to launch the plurality of software components, the HIL simulation platform is further configured to:
receive a single input from a user interface element of the launcher application; and
launch the plurality of software components based on the single input.

12. The system of claim 8, wherein the plurality of software components includes one or more of a simulator or an emulator.

13. The system of claim 8, wherein, to receive the component information, the HIL simulation platform is further configured to:
receive configuration information for a particular software component of the plurality of software components,
wherein the configuration information includes one or more of file path information identifying a file path for the particular software component, one or more parameters used when launching the particular software component, and log file information identifying a location of a log file for the particular software component.

14. The system of claim 8, wherein, to receive the component information, the HIL simulation platform is further configured to:
receive, via the launcher application, information regarding one or more additional software components;
update, by the launcher application, a configuration file regarding the plurality of software components
wherein the updated configuration file identifies the one or more additional software components, and
wherein the updated configuration file includes updated sequence information indicating an updated sequence for launching the plurality of software components and the one or more additional software components; and
launch, during another HIL simulation, the plurality of software components and the one or more additional software components in an order that is based on the updated sequence.

15. A non-transitory computer-readable medium storing a set of instructions, the set of instructions comprising:
one or more instructions that, when executed by one or more processors of a device, cause the device to:
receive, by a launcher application of the device, component information regarding a plurality of software components of a hardware-in-the-loop (HIL) simulation environment,
wherein the component information includes:
sequence information indicating a sequence for launching the plurality of software components during a hardware-in-the-loop (HIL) simulation;
launch, using the launcher application, the plurality of software components in an order that is based on the sequence,
wherein the plurality of software components are launched during the HIL simulation; and
monitor, by the launcher application, the plurality of software components to determine a failure associated with launching the plurality of software components.

16. The non-transitory computer-readable medium of claim 15, wherein the one or more instructions, that cause the device to launch the plurality of software components, cause the device to:
receive a single input from a user interface element of the launcher application; and
launch the plurality of software components based on the single input.

17. The non-transitory computer-readable medium of claim 15, wherein the one or more instructions further cause the device to:
perform, by the launcher application, an action based on monitoring the plurality of software components.

18. The non-transitory computer-readable medium of claim 17, wherein the one or more instructions, that cause the device to perform the action, cause the device to:
provide, using the launcher application, a first notification based on determining that a software component, of the plurality of software components, failed to launch; or
provide, using the launcher application, a second notification based on determining that the software component experienced a failure after being launched.

19. The non-transitory computer-readable medium of claim 15, wherein the HIL simulation is a first HIL simulation, and
wherein the one or more instructions further cause the device to:
store the component information;
receive a request to perform a second HIL simulation;
obtain, using the launcher application and based on the second request, the stored component information; and
launch, using the launcher application and based on the second request, the plurality of software components in an order that is based on the sequence.

20. The non-transitory computer-readable medium of claim 15, wherein the one or more instructions further cause the device to:
receive configuration information for a particular software component of the plurality of software components,
wherein the configuration information includes one or more of file path information identifying a file path for the particular software component, one or more parameters used when launching the particular software component, and log file information identifying a location of a log file for the particular software component.
